(19) United States
(12) Patent Application Publication
(10) Pub. No.: US 2007/0278867 A1
(43) Pub. Date: Dec. 6, 2007

(54) EXPOXY ENCAPSULATED STATOR

(75) Inventor: Marvin K. White, Lafayette, IN (US)

Correspondence Address: OVERHAUSER LAW OFFICES, LLC;PAUL B. OVERHAUSER, 737 W. GREEN MEADOWS DRIVE, SUITE 300, GREENFIELD, IN, 46140, US

(73) Assignee: Andover, Inc., a division of Cavu OPS, Inc., Terre Haute, IN (US)

(21) Appl. No.: 11/420,902

(22) Filed: May 30, 2006

(51) Int. Cl. H02K 1/04

(52) U.S. Cl. 310/43; 310/216; 310/217; 29/596

(57) ABSTRACT

A stator having electromagnetic poles that face an interior or center of a generally circular lamination of the stator includes coils that are encapsulated in epoxy. The outer surface of the epoxy and the outer surface of a laminate of the stator are in combination cylindrical. A method of manufacture includes providing a stator laminate having poles that face the center of the stator laminate. Coils that have been situated in the laminate are axially compressed such that the height of the coils, both on an upper and lower side, is axially decreased relative to the laminate. The stator is then situated into a mold. An epoxy resin is then applied to the mold resulting in the encasement or encapsulation of the upper and lower portions of the coils in epoxy. Epoxy encapsulation of the coils helps protect the stator from damage. The epoxy may also help dissipate heat from the coils.

### BACKGROUND OF THE INVENTION

1. Field of the Invention

The present invention relates to motor or magneto stators and, more particularly, to an epoxy encapsulated stator for a motor or magneto.

2. Background

A Stator is used in AC induction motors and magnetos. The stator includes a number of windings or coils that are situated in a metal lamination or stack. Through electromagnetic principles, portions of the lamination become electromagnetic poles that inductively cause a rotor of the motor or magneto to rotate. The rotor provides rotational movement that is then utilized as is known in the art.

When motors and/or magnetos are subjected to harsh environments such as in industrial engines or when they are used in connection with oil drilling, used in pumps and/or the like, failure of the motor is oftentimes traced to premature coil failure. If not for the premature failure of the coils, the motor and/or magneto would have a longer life. In situations where the motor and/or magneto is oftentimes left operating without intervention or maintenance for long periods of time, such premature failure can have unacceptable consequences.

Thus, it is evident from the above that there is a need for protecting against premature coil failure. It is also evident that there is a need for protecting coils of motors and/or magnetos such as are used in harsh environments.

### SUMMARY OF THE INVENTION

The present invention is an epoxy encapsulated stator and a method of manufacture.

In one form, the present invention provides a stator having a stator lamination or stack defining a plurality of poles that inwardly face a center of the stator lamination. The lamination carries a plurality of coils that have upper and lower portions that axially extend from the stator lamination. The upper and lower portions of the stator are encased in epoxy.

In one form, the outer surface of the epoxy and the outer surface of a laminate of the stator are in combination cylindrical. The epoxy thus does not contour the windings but forms an annulus around the upper portions of the windings axially above and on the stator laminate and an annulus around the lower portions of the windings axially below and on the stator laminate.

The method of manufacture includes providing a stator laminate having poles that face the center of the stator laminate. Coils that have been situated in the laminate are axially compressed such that the height of the coils, both on an upper and lower side, is axially decreased relative to the laminate. The stator is then situated into a mold. An epoxy resin is then applied to the mold resulting in the encasement or encapsulation of the upper and lower portions of the coils in epoxy.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a stator lamination or stack;

FIG. 2 is a perspective view of a stator conditioned for epoxy encapsulation in accordance with the principles of the present invention;

FIG. 3 is an exploded perspective view of a multiple part epoxy encapsulation mold ready to receive the conditioned stator of FIG. 2 for epoxy encapsulation thereof;

FIG. 4 is a perspective view of the bottom of an insert of the multiple part epoxy encapsulation mold;

FIG. 5 is a perspective view of the conditioned stator of FIG. 2 situated within the lower portion of the multiple part epoxy encapsulation mold with the insert of the epoxy encapsulation mold positioned in the conditioned stator but without the upper portion of the epoxy encapsulation mold;

FIG. 6 is a perspective view of the conditioned stator of FIG. 2 situated within the multiple part epoxy encapsulation mold as depicted in FIG. 5 but with the upper portion of the multiple part epoxy encapsulation mold situated thereon and clamped to the lower portion of the multiple part epoxy encapsulation mold; and

FIG. 7 is a perspective view of the conditioned stator of FIG. 2 after epoxy encapsulation in accordance with the principles of the present invention.

Like reference numerals indicate the same or similar parts throughout the several figures.

### DETAILED DESCRIPTION OF THE PREFERRED EMBODIMENT

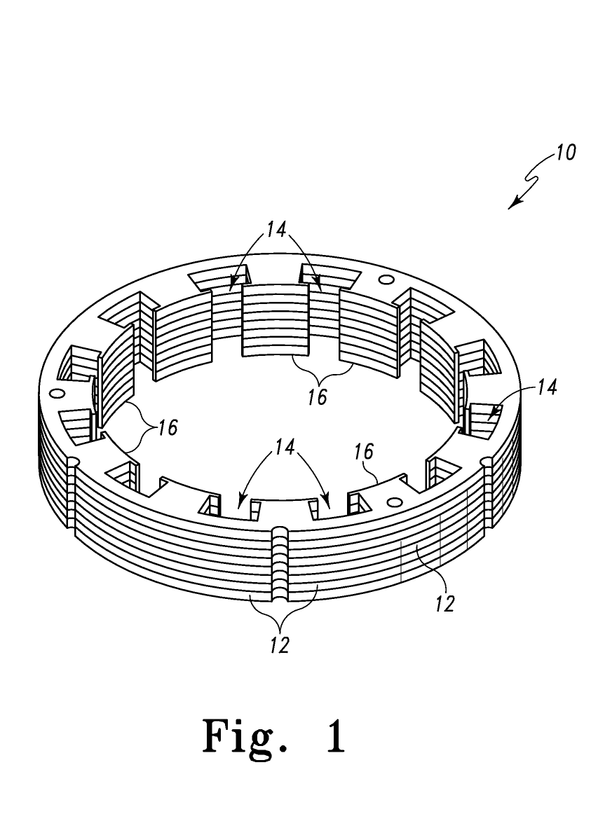

Referring to FIG. 1, there is depicted a perspective view of a stator lamination or stack 10 for making a stator for an AC induction motor in accordance with the principles of the present invention. The lamination 10 is formed of a plurality of identically configured stator rings or generally annular bodies 12 that are axially layered or stacked upon one another. Each stator ring 12 is formed of a magnetically susceptible metal (e.g. iron). Each ring 12 and thus the stator lamination 10 has a plurality of cavities 14 that are configured to receive wire windings and a plurality of plates or faces 16 that become magnetic poles as is known in the AC induction motor art. The poles 16 of the conditioned stator 20 thus face radially inward toward a center of the stator 20.

In FIG. 1, the stator lamination 10 is shown having twelve (12) cavities 14 and twelve (12) faces 16. It should be appreciated, however, that the stator lamination 10 is only exemplary of a stator lamination that may be used to form a stator in accordance with the present principles.

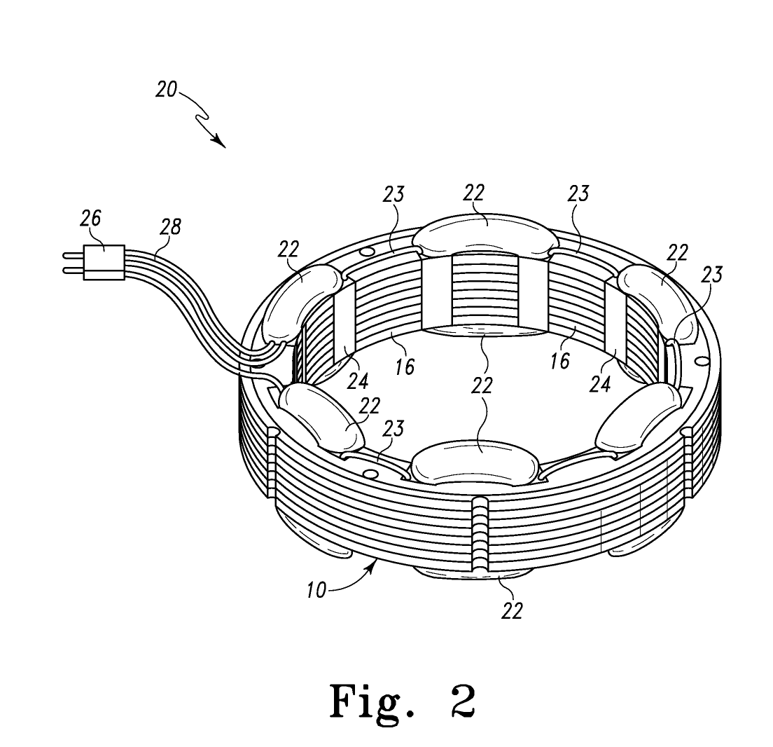

Referring to FIG. 2, an assembled and conditioned (in accordance with the present principles) stator 20 is shown. Six (6) wire windings or toroids 22 have been situated in the cavities 14 with inserts 24 retaining the windings 22. Wires 23 electrically couple the windings 22 in a known fashion. A wire bundle 28 connects the windings 22 to a connection plug 26. In accordance with one aspect of the subject invention, the upper and lower portions (relative to the stator 20 as shown in FIG. 2) of the windings 22 (i.e. those portions that are axially exposed relative to the lamination 10) are axially flattened as shown in FIG. 2 rather than keeping them rounded. Stated in another manner, the exposed top and bottom portions of the windings 22 are pushed axially into or towards the lamination 10. This creates a lower axial profile to the stator 20. This is termed a conditioned stator.

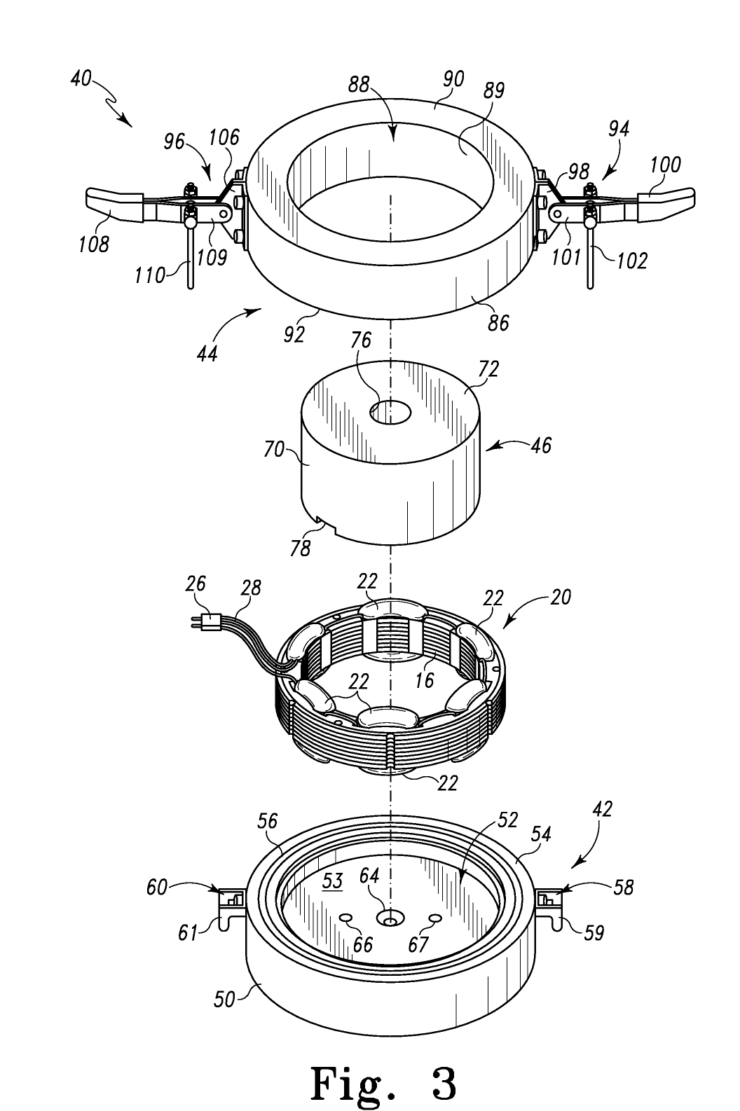

Referring now to FIG. 3, the conditioned stator 20 of FIG. 2 is ready to be inserted into an exemplary mold 40 for epoxy encapsulation or encasement. The epoxy encapsulation mold 40 includes three (3) components, namely a base 42, a top 44 and an insert 46. Each component is formed of a suitable mold material such as aluminum.

The base 42 is characterized by a generally annular body 50 having an annular cavity 52 therein that defines a bottom 53. The annular body 50 has an annular top 54 having an O-ring 56 situated in an annular groove in the annular top 54. The bottom 53 includes a center bore 64 and two side bores 66, 67. First and second clamp members 58, 60 are disposed on (e.g. bolted onto) opposite sides of the outside of the annular body 50. The first clamp member 58 has a downwardly extending flange 59. The second clamp member 60 also has a downwardly extending flange 61. The cavity 52 is sized to receive the conditioned stator 20.

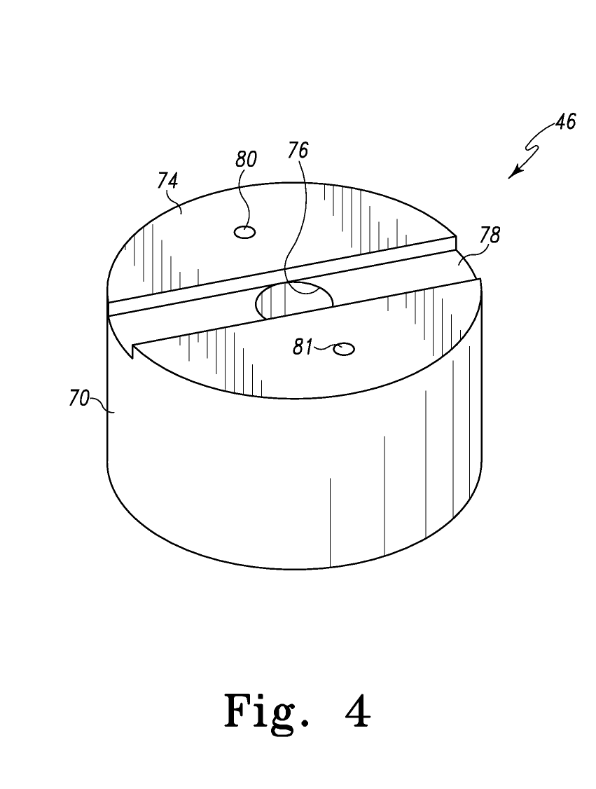

The insert 72 is characterized by a cylindrical body 70 defining a top surface 72 and a bottom surface 74. An axial bore 76 is provided in the body 70. The axial bore 76 extends through the body 70 from the top surface 72 to the bottom surface 74. A groove or channel 78 is disposed in the bottom surface 74. As best seen in FIG. 4, the groove 78 radially extends from one side of the body 70 to the other. The groove 78 allows the flow of liquid epoxy to reach the lower windings 22.

The body 70 is sized to fit into the interior of the conditioned stator 20. Particularly, the diameter of the body 70 is nearly the diameter of the interior of the stator 20 so that the interior of the stator 20 will not receive epoxy during the molding process. The poles 16 should be free from epoxy.

The top 44 is characterized by a generally ring-shaped or annular body 86 having a central cutout or opening 88 defining an interior annular surface 89. The body 86 defines an upper surface 90 and a lower surface 92. A first clamp structure 94 is disposed on the outside surface of the body 86. A second clamp stricture 96 is likewise disposed on the outside surface of the body 86 diametrically disposed thereon relative to the first clamp structure 94. The clamp structures 94, 96 are situated to correspond with the clamp members 58, 60 when the top 44 is received onto the base 42.

The clamp structure 94 includes a mount 98 that is attached to the body 86, an arm 101 that is pivotally attached at one end thereof to the mount 98, a handle 100 connected to another end of the arm 101, and a clamping ring 102 that is pivotally connected to the arm 101. The clamp structure 96 includes a mount 106 that is attached to the body 86, an arm 109 that is pivotally attached at one end thereof to the mount 106, a handle 108 connected to another end of the arm 109, and a clamping ring 110 that is pivotally connected to the arm 109. The rings 102, 110 are adapted to be received onto the clamp members 58, 60.

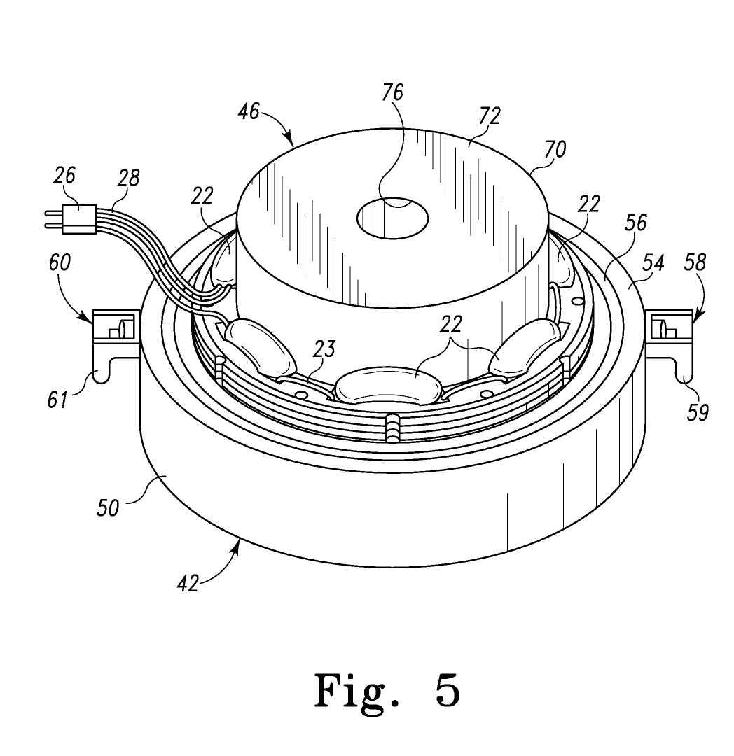

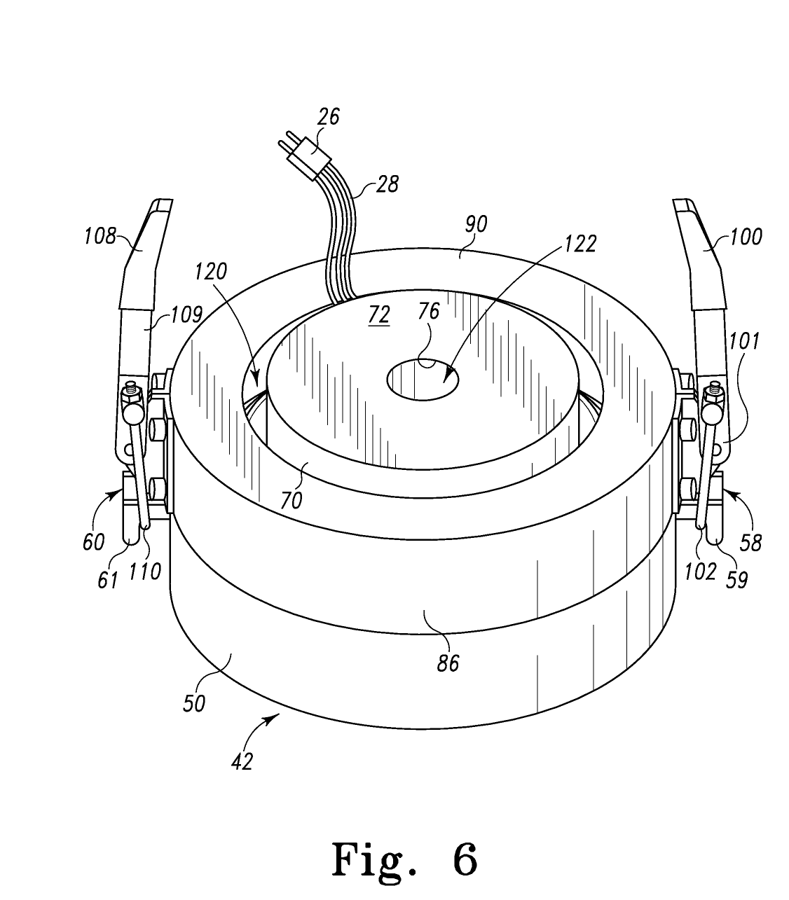

Referring to FIG. 5, there is shown the conditioned stator 20 situated into the base of the mold 42 with the insert 46 situated in the conditioned stator 20 ready to receive the top 44 of the mold. In FIG. 6, the top 44 has been positioned onto the base 42 and over the conditioned stator 20. The wire bundle 28 and connector 26 are extended through the annular opening 120 that is defined between the cylindrical outside of the insert 46 and the annular inside of the top 44.

The ring 102 of the clamp member 94 is received around the flange 59 of the clamp member 58 while the ring 110 of the clamp member 96 is received around the flange 61 of the clamp member 60. The handle 100 of the clamp member 94 is then pivoted or moved upward which pivots the arm 101 about the clamp member 58 such that the ring 102 of the clamp member 94 is held against the clamp member 58. Likewise, the handle 108 of the clamp member 96 is then pivoted or moved upward which pivots the arm 109 about the clamp member 60 such that the ring 110 is held against the clamp member 60. This tightens the top 44 against the base 42.

The liquid epoxy may now be poured into the mold 42. Particularly, the liquid epoxy may be introduced into the mold 42 through the annular channel 120 and into the bore 76 of the insert 46 as represented by the arrow 122. The epoxy flows into the channel 78 and around the windings 22 at the bottom of the stator 20. The epoxy also forms around the windings 22 at the top of the stator 20. To best encapsulate the stator, the mold may be subject to a vacuum pulling 1 mbar.

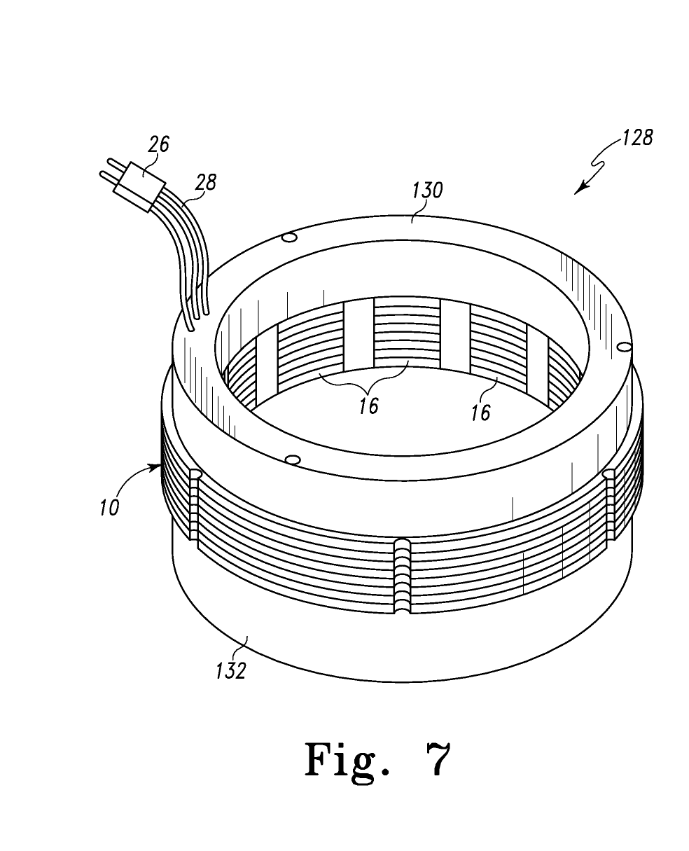

When the epoxy cures, the stator 20 is then removed from the mold 40. Any excess epoxy that may have covered a pole 16 is removed. A finished epoxy encapsulated stator 128 is shown in FIG. 7. A ring or annulus of epoxy 130 surrounds the upper portion of the windings 22 while a ring or annulus of epoxy 132 surrounds the lower portion of the windings 22. As can be discerned from FIG. 7, the outer surface of the epoxy and the outer surface of the laminate 10 are in combination cylindrical in shape (i.e. the epoxy does not contour the exposed surface of the windings 22. This results in a larger amount of epoxy covering the windings 22. This helps to protect the stator from damage from being dropped. It is also believed to assist in the dissipation of heat from the windings 22.

A method for forming or manufacturing the present epoxy encapsulated stator 128 includes providing a lamination or stack then inserting windings or coils as appropriate, the poles of the lamination facing the center of the stator. The windings are then axially compressed decreasing the axial height of the stator. The compressed or conditioned stator is then inserted into the mold. Epoxy is then poured into the mold. After the epoxy cures, the stator is removed from the mold. Any excess epoxy is removed from the poles.

The present method allows the stators to be made that can be retrofitted to existing magneto housing. If the height of the windings remained the same, the addition of the epoxy would not allow the stator to be used in existing magneto or motor housings. In the present fabrication method, the epoxy can then be applied without increasing the height of the stator.

It should be appreciated, however, that other styles or types of molds may be utilized to form the present epoxy encapsulated stator.

While the invention has been illustrated and described in detail in the drawings and foregoing description, the same is to be considered as illustrative and not restrictive in character, it being understood that only a preferred embodiment has been shown and described and that all changes and modifications that come within the spirit of the invention are desired to be protected.

What is claimed is:

1. A stator comprising:
a lamination defining a plurality of poles that face a center of the lamination;
a plurality of windings retained in the lamination, the plurality of windings each having an upper portion that extends from an upper portion of the lamination and a lower portion that extends from a lower portion of the lamination; and
epoxy encasing the upper and lower portions of the windings.

2. The stator of claim 1, wherein the lamination is annular.

3. The stator of claim 1, wherein an outer surface of the epoxy and an outer surface of the lamination are both cylindrical.

4. The stator of claim 1, wherein the epoxy encasing the upper portion of the windings is annular and the epoxy encasing the lower portion of the windings is annular.

5. The stator of claim 4, wherein the annular epoxy encasing the upper portion of the windings extends from an upper surface of the laminate, and the annular epoxy encasing the lower portion of the windings extends from a lower surface of the laminate.

6. A stator comprising:
a lamination having a circular outer periphery;
a plurality of windings retained in the lamination; and
epoxy encasing the plurality of windings;
the outer surface of the epoxy and the outer surface of the laminate being in combination cylindrical in shape.

7. The stator of claim 6, wherein the lamination defines a plurality of radially inwardly facing poles.

8. The stator of claim 6, wherein the epoxy annularly encases an upper portion of the extending from the laminate and annularly encases a lower portion of the windings extending from the laminate.

9. The stator of claim 8, wherein the annular epoxy encasing the upper portion of the windings extends from an upper surface of the laminate, and the annular epoxy encasing the lower portion of the windings extends from a lower surface of the laminate.

10. A method of manufacturing a stator comprising the steps of:
providing a laminate having poles that face a center of the stator;
retaining a plurality of coils in the laminate; and
encasing the plurality of coils in epoxy.

11. The method of claim 10, wherein an outer surface of the epoxy and an outer surface of the laminate are both cylindrical.

12. The method of claim 10, wherein the plurality of coils have an upper portion and a lower portion, the epoxy encasing the upper portion of the windings is annular and the epoxy encasing the lower portion of the windings being annular.

13. The method of claim 4, wherein the annular epoxy encasing the upper portion of the windings extends from an upper surface of the laminate, and the annular epoxy encasing the lower portion of the windings extends from a lower surface of the laminate.

14. A method of manufacturing a stator comprising the steps of:
providing a laminate having a plurality of coils each having an upper portion axially extending from an upper surface of the laminate and a lower portion axially extending from a lower portion of the laminate;
axially compressing the upper surface of the plurality of coils;
axially compressing the lower surface of the plurality of coils; and
encasing the compressed upper and lower portions of the plurality of coils in epoxy.

15. The method of claim 14, wherein the epoxy encasing the compressed upper portion of the plurality of coils is annular and the epoxy encasing the compressed lower portion of the plurality of coils is annular.
